(19) United States
(12) Patent Application Publication
(10) Pub. No.: US 2011/0298899 A1
(43) Pub. Date: Dec. 8, 2011

(54) IMAGE CAPTURING APPARATUS AND CONTROL METHOD THEREOF

(76) Inventor: Tomonori Masuda, Saitama (JP)

(21) Appl. No.: 13/120,867

(22) PCT Filed: Oct. 14, 2010
(86) PCT No.: PCT/JP2010/068038

§ 371 Date: Aug. 19, 2011

(30) Foreign Application Priority Data
Mar. 25, 2010 (JP) 2010-069312

(51) Int. Cl. H04N 13/02

(52) U.S. Cl. 348/47; 348/46; 348/E13.074

(57) ABSTRACT

Recording of an unnecessary widespread image will be prevented.

The first camera and the second camera capture a parallax image. In a setting mode, each of these camera is zoomed to a focal length for general view at which the whole of the measurement object can be captured, and captures a widespread image for displaying a through image. After having set a focal length and a capturing targeted part for capturing the parallax image in the setting mode, when capturing of the parallax image is instructed, an image of the capturing targeted part of the widespread image for displaying the through image is examined so as to judge the necessity or not of recording of the widespread image. When it is judged that recording of the widespread image is necessary, a still image of the widespread image is captured with use of the first camera and then each camera is zoomed to a focal length for measurement and captures the parallax image. The widespread image on which a guidance frame showing a range of the parallax image is composed is recorded with the parallax image.

### TECHNICAL FIELD

The present invention relates to an image capturing apparatus to obtain three-dimensional information and a control method thereof.

### BACKGROUND ART

As an image capturing apparatus to obtain three-dimensional information of a measurement object, for example a stereocamera is known. The stereocamera locates a pair of camera with a certain distance in right and left between them, captures a measurement object as the subject, and gets a parallax image. The parallax image consists of a pair of right and left perspective images captured by each camera. Based on the parallax of a correspondence point on each perspective image, three-dimensional information of a measurement object, that is, coordinate value in a three-dimensional space of any point of the measurement object, can be obtained.

An object distance becomes the shorter, or a focal length of a taking lens becomes the longer, the resolving power of the three-dimensional information obtained as described above becomes the higher. Therefore, usually an object distance is shortened to capture a part of a measurement object, with use of a taking lens having a relatively long focal length. However, when image capturing is performed on such a condition, depending on a shape or a surface pattern of the measurement object, there possibly becomes a problem that a image capturing point of the measurement object cannot be found only by referring to the recorded perspective image.

As known by patent documents 1 and 2, there are apparatuses which capture and record a widespread image of an object and a magnified image of an area which is a subject to measurement or monitoring, so as to easily determine which area of the object is the area for the measurement or the monitoring.

### PRIOR ART DOCUMENTS

### Patent Documents

Patent Document 1: Japanese Patent Laid-Open Publication No. 8-223466
Patent Document 2: Japanese Patent Laid-Open Publication No. 2003-227706

### SUMMARY OF THE INVENTION

### Problems to be Solved by the Invention

By the way, to capture and record the widespread image of the measurement object in addition to the parallax image obtained from capturing a part of the measurement object, extra operating time and record capacity to capture the widespread image are necessary, but it is not effective to capture and record a widespread image in case that it can be easily recognized which part of the measurement object is the image capturing point of the parallax image. On the other hand, when whether there is a necessity or not of capturing and recording of the widespread image is determined by the judgment of an operator at the time of the capturing, since individual difference occurs in the judgment, there occurs a problem that other users cannot distinguish the image capturing point.

The present invention is made in view of the problems mentioned above, and intends to provide an image capturing apparatus which can perform image capturing to obtain three-dimensional information of a measurement object effectively and a control method thereof, without recording an unnecessary widespread image.

### Means for Solving the Problems

To achieve the above-described problem, an image capturing apparatus of the present invention comprises an image capturing section, a judgment section and a record control section. The image capturing section includes a plurality of cameras including a first camera having a taking lens of variable-focus type. When capturing a parallax image as the measurement image to measure three-dimensional information, each camera captures a measurement part of a measurement object in the same focal length. When capturing a widespread image of the measurement object including the measurement part, the first camera performs the image capturing with a shorter focal length of the taking lens than the focal length for capturing the parallax image. The judgment section judges whether recording of the widespread image is necessary or not, based on an image of the measurement part or a neighboring part in the measurement object obtained from the image capturing section. When the judgment section judges that recording of the widespread image is necessary, the record control section generates and records an image having a guide which represents a range of the parallax image and is superimposed on the widespread image.

When the image capturing section captures the widespread image, the focal length of the first camera is preferably at the wide-angle end.

In addition, an image capturing apparatus of the present invention comprises a projector, an image capturing section, a judgment section and a record control section. The projector projects measurement light onto a measurement object. The image capturing section includes a camera with a taking lens of variable-focus type. The image capturing section captures a measurement image of a measurement part in a measurement object on which the measurement light is projected when capturing the measurement image to measure three-dimensional information, and performs the image capturing with a shorter focal length of the taking lens than the focal length for capturing the measurement image when capturing a widespread image of the measurement object including the measurement part. The judgment section judges whether recording of the widespread image is necessary or not, based on an image of the measurement part or a neighboring part in the measurement object obtained from the image capturing section. When the judgment section judges that recording of the widespread image is necessary, the record control section generates and records an image having a guide which represents a range of the parallax image and is superimposed on the widespread image.

It is preferable that the judgment section judges that recording of the wide spread image is necessary, when the judgment section cannot detect a distinctive pattern in the measurement image.

It is also preferable that the judgment section judges that recording of the wide spread image is necessary, when a degree of similarity between the measurement image and the image of the neighboring part is higher than a predetermined level.

It is also preferable that the judgment section detects a correspondence point of the parallax image captured by the plurality of cameras, and judges whether recording of the widespread image is necessary or not, based on the detection result of the correspondence point.

It is also preferable that the judgment section detects a reference point corresponding to the correspondence point on a one-to-one basis, and judges that recording of the widespread image is unnecessary when the number of the detected reference point is at least a predetermined value N (N is at least 1), and that recording of the widespread image is necessary in other cases.

It is also preferable that the judgment section detects a reference point where a plurality of correspondence point candidates which are candidates of the correspondence point are found, and judges that recording of the widespread image is unnecessary when the number of the detected reference point is less than a predetermined value M (M is at least 1), and that recording of the widespread image is necessary in other cases.

It is also preferable that the judgment section judges that recording of the widespread image is unnecessary when the judgment section detects a reference point corresponding to the correspondence point on a one-to-one basis and the number of the detected reference point is at least a predetermined value N (N is at least 1), and detects a reference point where a plurality of correspondence point candidates which are candidates of the correspondence point are found and the number of the detected reference point is less than a predetermined value M (M is at least 1), and that the judgment section judges that recording of the widespread image is necessary in other cases.

Furthermore, in a control method of an image capturing apparatus of the present invention, whether recording of a widespread image being captured with a shorter focal length of a taking lens than a focal length for capturing a measurement image is necessary or not is judged based on an image of a measurement part or a neighboring part in a measurement object, and when recording of the widespread image is judged to be necessary, an image having a guide which represents a range of the parallax image and is superimposed on the widespread image is generated and recorded.

### Effect of the Invention

According to the present invention, since whether recording of the widespread image is necessary or not is judged with use of the image of the measurement part or the neighboring part of the measurement object, and it is controlled to generate and record the image having the guide which represents a range of the parallax image and is superimposed on the widespread image when the recording is judged to be necessary, it can get rid of waste and improve efficiency because recording of the widespread image is not carried out when it is found that the measurement image is which part of the image capturing point of the measurement object. In addition, since whether the recording is necessary or not is judged with use of the image, influence by an individual difference of the judgment of the operator disappears, and recording of the widespread image is permitted or not appropriately corresponding to availability of the identification of the image capturing point.

### BRIEF DESCRIPTION OF THE DRAWINGS

FIG. 1 A block diagram illustrating a constitution of a three-dimensional information obtaining device which carried out the present invention.

FIG. 2A An explanatory diagram illustrating a widespread image with a frame displayed on a display section.

FIG. 2B An explanatory diagram illustrating a right perspective image captured with a first camera.

FIG. 2C An explanatory diagram illustrating a left perspective image captured with a second camera.

FIG. 3 An explanatory diagram illustrating a display example of an analysis result of three-dimensional information.

FIG. 4 A flowchart illustrating image capturing procedures.

FIG. 5 A flowchart illustrating a judgment process in which judgment is performed based on whether a distinctive pattern is detected or not.

FIG. 6 A flowchart illustrating a judgment process in which judgment is performed based on a degree of similarity between a capturing targeted part and a neighboring part of a parallax image.

FIG. 7 An explanatory diagram illustrating a relationship between the capturing targeted part and the neighboring part of a parallax image.

FIG. 8 An explanatory diagram illustrating a state that a part of the neighboring part is superimposed on the capturing targeted part of the parallax image.

FIG. 9 A flowchart illustrating a judgment process in which judgment is performed based on a detection result of a correspondence point.

FIG. 10 A perspective view illustrating a constitution in which a camera for capturing the widespread image is provided in addition to the first and second cameras.

FIG. 11 It is a block diagram illustrating a constitution of a three-dimensional information obtaining device which acquires three-dimensional information by light-section method.

FIG. 12 A flowchart illustrating image capturing procedures of the three-dimensional information obtaining device in light-section method.

FIG. 13 A perspective view illustrating a constitution in which a camera for capturing the widespread image is provided in the three-dimensional information obtaining device in light-section method.

### EMBODIMENTS FOR IMPLEMENTATION OF THE INVENTION

### First Embodiment

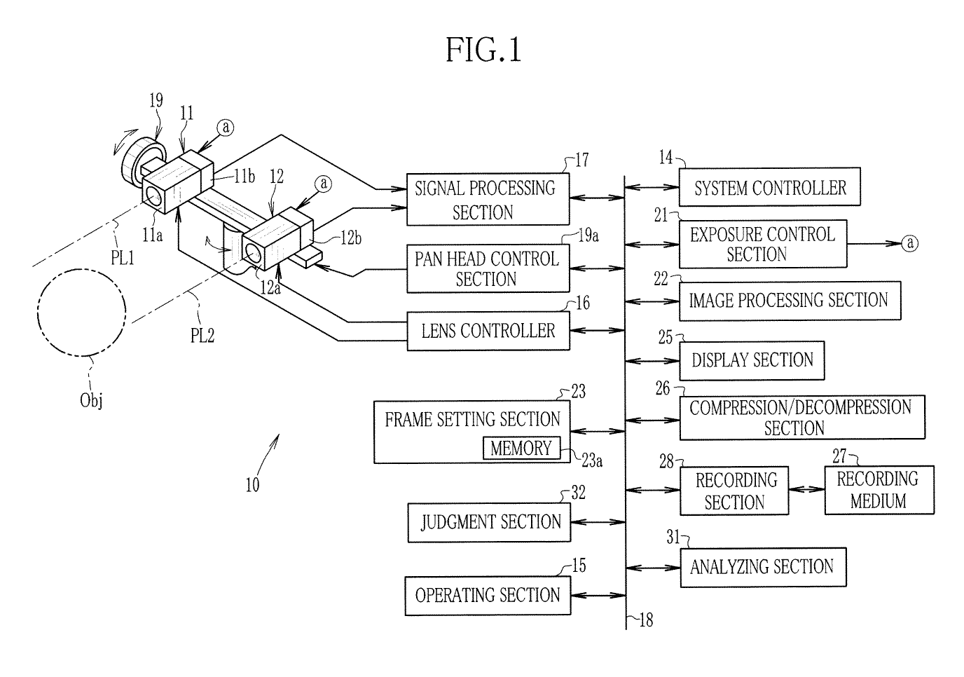

FIG. 1 illustrates a constitution of a three-dimensional information obtaining device of a first embodiment. The three-dimensional information obtaining device 10 includes an image capturing apparatus of the present invention. The three-dimensional information obtaining device 10 captures a parallax image of a measurement object Obj with use of a first camera 11 and a second camera 12, analyzes the parallax image and acquires three-dimensional information of the measurement object Obj, that is, coordinate value (Xi, Yi, Zi) of arbitrary point Pi on the measurement object in three-dimensional space. The parallax image as the measurement image is a set of each perspective image captured by a different viewpoint, and in the three-dimensional information obtaining device 10, it is from a left perspective image captured by a first camera 11 and a right perspective image captured by a second camera 12.

A system controller 14 performs overall control of each section of the three-dimensional information obtaining device 10. By operating an operating section 15, setting of a focal length, instructions of image capturing, instructions of an analysis of the parallax image and so on can be performed.

As operating modes of the three-dimensional information obtaining device 10, there are a setting mode for setting a measurement range of the measurement object Obj, a widespread image capturing mode for capturing a widespread image, a measurement capturing mode for capturing the parallax image, and an analysis mode for analyzing the parallax image and acquiring the three-dimensional information. In the setting mode, setting of the measurement range is performed by operating the operating section 15. Setting of the measurement range includes setting of a focal length (an image capturing angle of view) for capturing the parallax image, that is, a width of an image capturing range, and setting of the capturing targeted part on the measurement object Obj.

As described above, the three-dimensional information obtaining device 10 is provided with the first camera 11 and the second camera 12. The first camera 11 and the second camera 12 is arranged in a direction where optical axes PL1, PL2 become parallel to each other, and have a constant interval in a horizontal direction. Note that the optical axes PL1, PL2 are arranged to be parallel in this case, but the first camera 11 and second camera 12 can also be arranged with a suitable convergence angle between them. In addition, the arrangement direction of the first camera 11 and second camera 12 is not limited to the horizontal direction. For example, the first camera 11 and second camera 12 may be arranged in a vertical direction. In addition, each perspective image from 2 viewpoints is captured in this case, but it may be a constitution in which each perspective image from more than 3 viewpoints is captured.

The first camera 11 includes a taking lens 11a and an image sensor section 11b. This first camera 11 converts an optical image imaged at the taking lens 11a into an electrical signal in the image sensor section 11b and outputs it. The image sensor section 11b includes for example an image sensor of a CCD type or a MOS type. The taking lens 11a is the zoom type that can change a focal length between a wide end and a tele end. By zooming of the taking lens 11a, a width of the image capturing range of the first camera 11 can be controlled. Like the first camera 11, the second camera 12 includes a taking lens 12a of the zoom type and an image sensor section 12b.

A lens controller 16 controls a focal length of each taking lens 11a, 12a so that each focal length becomes same to each other. In the setting mode and the widespread image mode, the lens controller 16 controls the focal length of each taking lens 11a, 12a to become a focal length for general view, and in the measurement capturing mode, the focal length of each taking lens 11a, 12a is controlled to become a focal length for measurement which is set under the setting mode. Note that when the widespread image is captured, it may be that at least the camera which really captures the widespread image is controlled to have the focal length for general view. Therefore, it may be that the first camera 11 is controlled to change between the focal length for general view and the focal length for measurement, and that the second camera 12 is controlled to keep the focal length for measurement.

The widespread image is used to show which part of the measurement object Obj is to be captured as the parallax image and from which part the image is captured. Therefore, the widespread image does not need to include the entire measurement object. In other words, the measurement object Obj may be not captured partially as long as a position of the capturing targeted part on the measurement object Obj can be found. The focal length for general view is the focal length for capturing the above-mentioned widespread image, and is preset by an operator according to a size of the measurement object, for example as the focal length with which whole of the measurement object Obj can be captured. Note that the focal length of the wide-angle end of each taking lens 11a, 12a may be set as the focal length for general view.

In addition, the lens controller 16 controls a focus of each taking lens 11a, 12a based on image data from a signal processing section 17 which is described later, so that the focus is on the measurement object Obj. The adjustment of the focus is performed by for example contrast detection method, but may be performed also by other methods.

A pan head 19 is controlled by a pan head control section 19a. The first and second cameras 11, 12 are attached to the pan head 19. A pan head control section 19a drives the pan head 19 according to operation of the operating section 15 to swing a capturing direction of the first and second cameras 11, 12 in the horizontal and vertical directions. Accordingly, the capturing targeted part can be changed with fixing the measurement object Obj.

Note that the capturing targeted part may be changed by sliding the first and second cameras 11 and 12 in the horizontal and vertical directions. In addition, in this example, although the pan head 19 is fixed such that the capturing direction is the same in the widespread image capturing mode and the measurement capturing mode so that a capturing range of the parallax image is located in the center of the widespread image, the measurement capturing mode and the capturing direction may be changed so that whole of the measurement object Obj is captured as widespread image in the setting mode and the widespread image capturing mode.

The signal processing section 17 includes a correlative double sampling circuit which is provided according to each camera 11,12, an amplifier circuit, an A/D converter and so on. After having made noise removal and signal amplification on output signal from each camera 11, 12, the signal processing section 17 makes digital conversion and outputs obtained image data to a bus 18.

Each of the sections such as the system controller 14, the lens controller 16 and the signal processing section 17 is connected to the bus 18, and can send and receive data and various instructions through the bus 18.

An exposure control section 21 activates each camera 11, 12 to capture the parallax image and the widespread image. When image capturing, the exposure control section 21 controls an electronic shutter speed of each camera 11, 12 so that the measurement image and the widespread image can be captured with correct exposure. In the setting mode and the widespread image capturing mode, only one camera, for example the first camera 11 performs image capturing. The first camera 11 performs image capturing for displaying through images in the setting mode and captures a still image in the widespread image capturing mode. In the measurement capturing mode, each of the first camera 11 and the second camera performs image capturing.

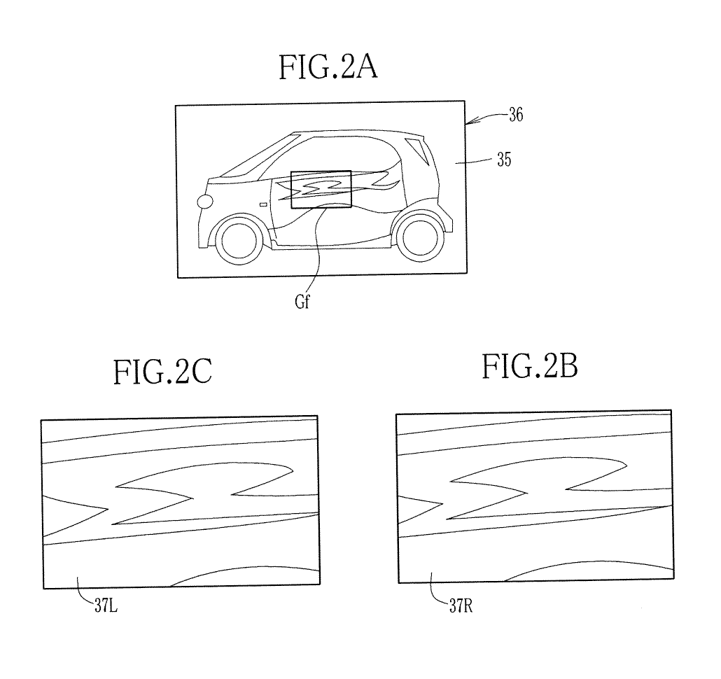

An image processing section 22 performs white balance correction and gamma correction for the captured widespread image and parallax image. In addition, the image processing section 22 performs a frame composition process in which the widespread image with a frame is generated by composing a guidance frame Gf (see FIG. 2), which shows a range to be captured as the parallax image, on the widespread image. The frame composition process is performed based on focal length information for measurement from a frame setting section 23 which is described later.

Since the widespread image and the parallax image (the right perspective image) are captured with the same capturing direction and different focal lengths of the first camera 11, the centers of those images coincide. Therefore, in the frame composition process, the image composition is performed such that the center of the guidance frame Gf coincides with the center of the widespread image and that the guidance frame Gf of the size corresponding to an image capturing angle of view shown in the focal length information for measurement is superimposed.

A display section 25 includes a VRAM for memorizing image data of an image which should be displayed, a driver for generating a drive signal based on the image data memorized in the VRAM, a monitor which is driven by the drive signal from the driver so as to display the image, and so on.

Under the setting mode, data which is the widespread image obtained from first camera 11 with application of the frame composition process, that is, the widespread image with the frame is sequentially input into and displayed on the display section 25. Therefore, an operator can find which part of the measurement object Obj becomes the capturing targeted part, through the guidance frame Gf superimposed and displayed on the widespread image on being captured by the first camera 11 as the through images which is being observed. Under the analysis mode, for example the widespread image with the frame, the parallax image, the three-dimensional information which is obtained by analyzing the parallax image, and so on are displayed on the display section 25.

When the parallax image and the widespread image with the frame are recorded in a recording medium 27, a compression/decompression section 26 compresses those data in a predetermined form. In addition, the compression/decompression section 26 decompresses the parallax image and the widespread image with the frame read from the recording medium 27. The decompressed parallax image is sent to the display section 25 and an analyzing section 31, and the widespread image with the extended frame is sent to the display section 25. Note that it is preferable that compressibility for compressing image is larger for the widespread image than for the measurement image.

A recording section 28 performs writing and reading the image data to/from the recording medium 27. When it is judged that recording of the widespread image is necessary through a judgment process which is described later in detail, the recording section 28 generates one file including each data of the widespread image with the frame and the parallax image and records this file. In this file to be recorded, information such as the measurement focal length used for capturing the parallax image, which is necessary for analyzing the three-dimensional information, is also recorded. On the other hand, when it is judged that recording of the widespread image is unnecessary, the recording section 28 generates a file including only the parallax image as the image data and records it. When the file is read from the recording medium 27, the recording section 28 sends the parallax image and the widespread image with the frame included in the file to the compression/decompression section 26.

Note that in this example, the widespread image with the frame and the measurement image are associated by recording them as one file, but the association method is not limited to this. For example, it may be that the widespread image with the frame and the parallax image are recorded as different files and a name of one file related to tags contained in these files is recorded in the other file, or it may be that a file for associating both files is recorded. As a substitution for the recording medium 27, a memory or a hard disk may be used for recording.

In addition, it is preferable that a thumbnail image is made from the widespread image or the widespread image with the frame, and this thumbnail image becomes a thumbnail image of the file. According to this way, a file including a necessary parallax image can be found quickly.

The frame setting section 23 sets a focal length for measurement in the measurement capturing mode and memorizes the focal length for measurement in a memory 23a. The setting of the focal length for measurement is performed in response to a setting operation of the image capturing angle of view by the operating section 15 under the setting mode. The focal length for measurement memorized in the memory 23a is sent to the image processing section 22 as the focal length information for measurement and is used when the widespread image with the frame is generated. In addition, in the measurement capturing mode, the focal length for measurement which is memorized in the memory 23a is referred to by the lens controller 16, and the first and second cameras 11 and 12 are controlled to perform zooming to become this focal length for measurement.

A judgment section 32 performs the judgment process in which whether recording of the widespread image with the frame is necessary or not is judged. In the judgment process, the judgment section 32 performs the judgment of whether recording of the widespread image is necessary or not, in terms of whether the capturing targeted part captured as the parallax image is discriminable from other parts or not. In this example, with use of the widespread image captured in the setting mode, an area equivalent to its parallax image (the capturing targeted part of the measurement image) is examined, then it is judged that recording of the widespread image with the frame is unnecessary when the distinctive pattern can be detected in this area, and it is judged that recording of the widespread image with the frame is necessary when the distinctive pattern cannot be detected.

The distinctive pattern may include a shape or a mark that are expressed by for example an arrangement of points and lines, an arrangement and a shade of color or those combinations, and so on. In addition, the distinctive pattern may be a predetermined pattern. In addition, at the point of view whether the distinctive pattern can be distinguished from other parts, it is preferable to judge that the distinctive pattern cannot be detected when a similar pattern is repeated and it is supposed that a surrounding area of the parallax image has an arrangement of similar patterns. When it is judged that recording of the widespread image with the frame is necessary, the parallax image is captured as the measurement capturing mode after the widespread image is captured as the widespread image capturing mode.

Although the judgment section 32 performs the judgment with using the widespread image captured under the setting mode, for example, it may be that the second camera 12 is set in the focal length for measurement under the setting mode and the judgment is performed with using the perspective image captured by the second camera 12. In addition, it may be that the judgment process is performed after image capturing in the measurement capturing mode, in this case, either of the perspective images captured in the measurement capturing mode may be used for the judgment.

The analyzing section 31 analyzes the parallax image and obtains three-dimensional information of each area of the measurement subject by calculation. In this analysis, one of each perspective image, for example the left perspective image is determined as a standard image and the other is determined as a reference image, and it is calculated that parallax of a reference point (a pixel) in the standard image and a correspondence point in the reference image which is captured an equivalence point of the reference point, then it is calculated that a distance in a direction parallel to an optical axis of the taking lens (a distance in a depth direction) in a parallel direction, and coordinates in a plane direction which is perpendicular to the depth direction, based on the parallax, a pixel size of each camera 11 and 12, a focal length and an object distance, and a camera interval (a base length). The calculated three-dimensional information is displayed on the display section 25, and is recorded in the recording medium 27 through the recording section 25.

An example of a display screen of the display section 25 in the setting mode is illustrated in FIG. 2A. On the display screen of the display section 25, the widespread image with the frame 36, which is the composition of the widespread image 35 and the guidance frame Gf thereon, is displayed. An area shown by the guidance frame Gf is about the same with an image capturing range of the right perspective image 37R illustrated in FIG. 2B and the left perspective image 37L illustrated in FIG. 2C.

Note that in this example, since the center of the guidance frame Gf coincides with the center of the widespread image 35 to be captured with the first camera 11, the area shown by the guidance frame Gf becomes about the same with the area of the right perspective image 37R. However, since the image capturing ranges of each perspective image of right and left are different in a precise sense, it may calculate an overlap area of the left perspective image and the right perspective image and may display the overlap area as the frame. Also the frame at the time of the record may show the overlap area. In addition, it may display an image captured with the focal length for measurement on the display section 25 under the setting mode.

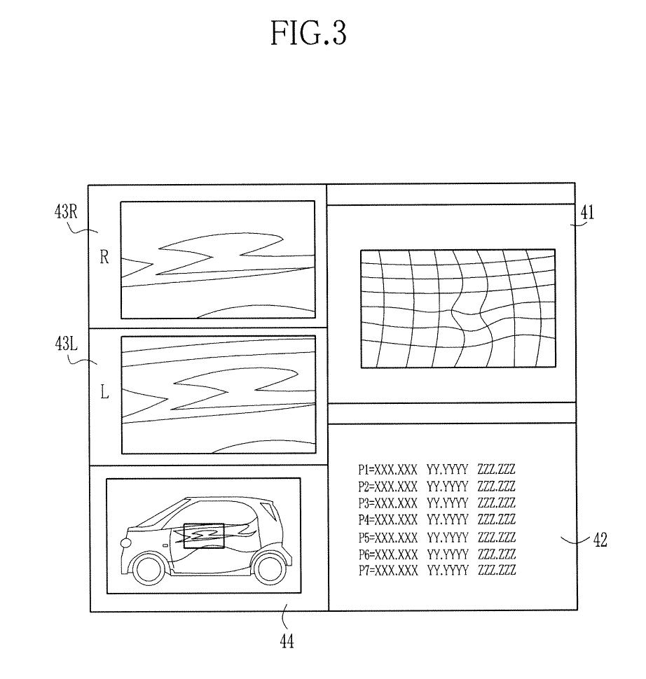

FIG. 3 illustrates an example of a display state of the display section 25 under the analysis mode. On the right half of the display screen of the display section 25, a graphic display area 41 and a data display area 42 are provided. On the graphic display area 41, it is displayed a graphic which visualized a shape of the measurement part of the measurement object Obj generated based on the three-dimensional information analyzed from the parallax image. On the data display area 42, the data of the analyzed three-dimensional information is displayed.

On the left half of the display section 25, a right perspective image area 43R, a left perspective image area 43L, and a widespread image area 44 are provided. On the right perspective image area 43R and the left perspective image area 43L, a right perspective image and a left perspective image are displayed, and the widespread image with the frame is displayed on the widespread image area 44. Note that it is not displayed when the widespread image with the frame is not recorded.

Next, an operation of the above constitution is described. When capturing the measurement object Obj, at first the measurement object Obj is located in front of the cameras 11 and 12. Then an operator operates the operating section 15 to set the three-dimensional information obtaining device 10 to the setting mode.

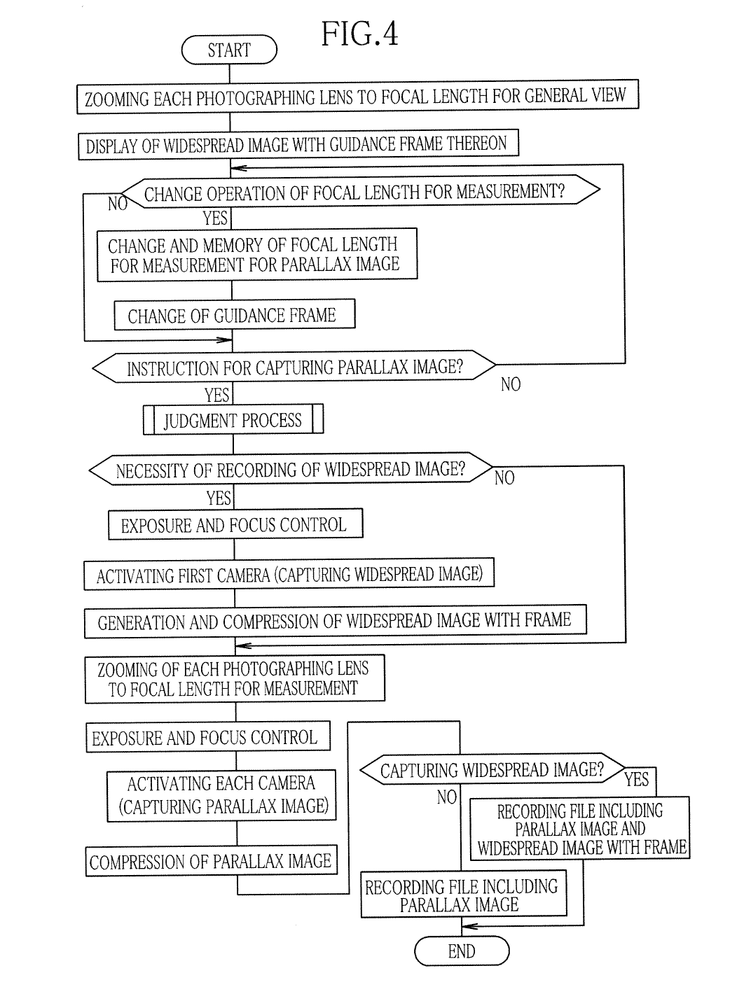

When it becomes the setting mode, as illustrated in FIG. 4, under the control of the lens controller 16, each taking lens 11a, 12a is zoomed to the focal length for general view. In addition, capturing of video with use of the first camera 11 is started after becoming setting mode, then the captured image, that is, the widespread image is sent to the image processing section 22 through the signal processing section 17. The focal length information for measurement which is formerly set in the frame setting section 23 is input into the image processing section 22. Therefore, the widespread image with the frame, on which the guidance frame Gf indicating an image capturing range corresponding to the focal length for measurement is composed, is generated on the widespread image which is being captured and sent to the display section 25 so as to be displayed.

While observing the widespread image with the frame displayed on the display section 25, the operator operates the operating section 15 so that a part of the measurement object Obj which is going to be measured is entered inside the guidance frame Gf, and activates the pan head 19 to regulate the capturing direction of each camera 11, 12. In addition, by operating the operating section 15, the focal length for measurement is controlled. When the control of the focal length for measurement is performed, the focal length of each camera 11, 12 is maintained at the focal length for general view at this time, but the focal length for measurement which is set and memorized in the frame setting section 23 is changed. Therefore, in response to this change, a size of the guidance frame Gf composed on the widespread image which is being captured is varied. Accordingly, by observing the widespread image with the frame displayed on the display section 25, the operator can find the capturing targeted part to be captured as the parallax image.

By the above operation, after the capturing targeted part is set at the desired range and position, image capturing of the parallax image is commanded through the operation of the operating section 15. According to these instructions, at first the judgment process for judging whether recording of the widespread image is necessary or not is performed by the judgment section 32.

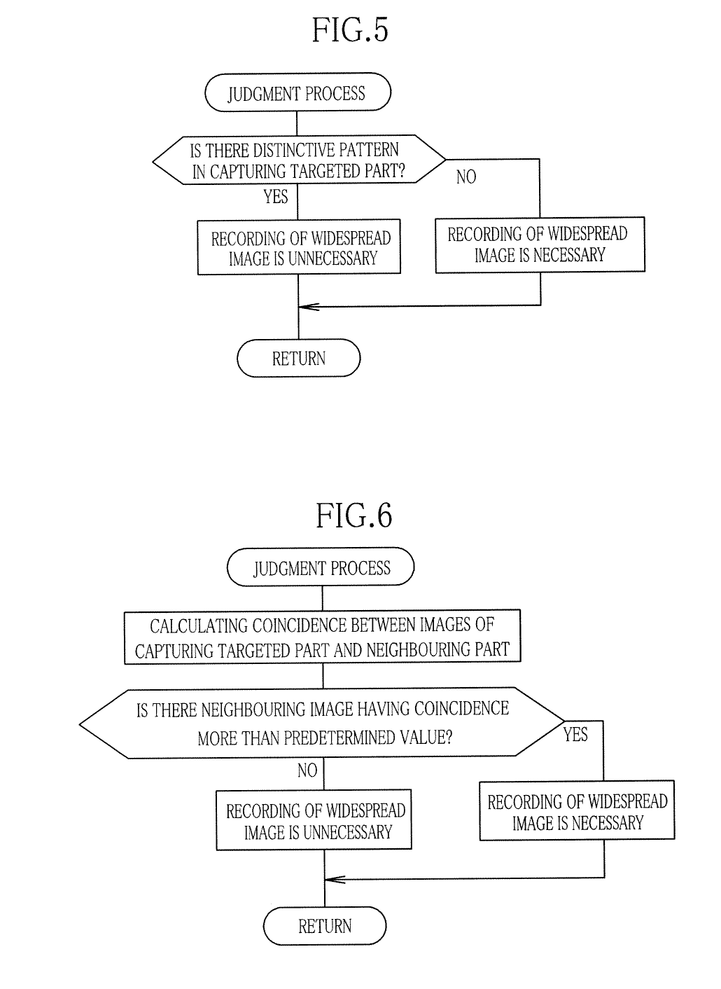

In the judgment process, as illustrated in FIG. 5, the widespread image for one frame which is being captured by the first camera 11 at this time is extracted, and it is examined whether the distinctive pattern is detected in the area that should become the capturing targeted part in the widespread image. When the distinctive pattern is detected, the mode shifts to the measurement capturing mode because recording of the widespread image becomes not necessary, and when it is not detected, the mode shifts to the widespread image capturing mode because recording of the widespread image becomes necessary.

For example, when the distinctive pattern is not detected and the mode shifts to the widespread image capturing mode, exposure control and focusing of the first camera 11 are performed with keeping the focal length for general view, so as to capture still images. Accordingly, capturing of the widespread image to be recorded is carried out, and the widespread image with the frame is generated by composing the guidance frame Gf on the widespread image in the image processing section 22. The generated widespread image with the frame is sent to the compression/decompression section 26 for data compression, and then is sent to the recording section 28.

Note that instead of carrying out the widespread image capturing mode and capturing the widespread image, it may use the widespread image for one frame captured in the setting mode when the capturing of the parallax image is instructed or just before that.

After the above-described generation of the widespread image with the frame, or after the judgment that recording of the widespread image is unnecessary, the mode is shifted to the measurement capturing mode. When it becomes the measurement capturing mode, the focal length for measurement set and stored in the frame setting section 23 is referred by the lens controller 16, and then each camera 11, 12 is zoomed to become this focal length.

After the zooming, exposure control and focusing of the first and second cameras 11 and 12 are carried out, and then image capturing of still images is carried out by each camera 11, 12. Accordingly, a parallax image, which is composed of a right perspective image and a left perspective image which are made by capturing the capturing targeted part of the measurement object Obj shown by the guidance frame Gf on the widespread image, is captured. Then the parallax image is sent to the compression/decompression section 26 for the data compression, and is sent to the recording section 28.

When the parallax image is input into the recording section 28, the file including the widespread image and the parallax image with the frame is generated, and then is recorded in the recording medium 27. Note that when it is judged that recording of the widespread image is unnecessary, a file including only the parallax image is generated and is recorded in the recording medium 27.

When analyzing the parallax image, the operating section 15 is operated to set the analysis mode. Note that the mode may be automatically shifted to the analysis mode after the measurement capturing mode. Under the analysis mode, the operating section 15 is operated to select the file recorded in the recording medium 27, which should be analyzed.

The selected file is read from the recording medium 27 by the recording section 28, and an image included therein is taken out. For example, when the selected file includes the parallax image and the widespread image with the frame, each of those images is taken out from the file, and is decompressed by the compression/decompression section 26. After that, the parallax image and the widespread image with the frame are sent to the display section 25 and are respectively displayed in the right perspective image area 43R, the left perspective image area 43L, and the widespread image area 44. The operator can find that the parallax image is from which part of the measurement object, by referring to the widespread image with the frame shown displayed in the widespread image area 44.

In addition, the parallax image is sent to the analyzing section 31, then the three-dimensional information which is obtained by analyzing in the analyzing section 31, and the graphic which is the visualization of the result are sent to the display section 25 and are respectively displayed on the data display area 42 and the graphic display area 41.

In the judgment process of the above embodiment, although it judges whether recording of the widespread image is necessary or not based on whether the distinctive pattern can be detected or not from the capturing targeted part of the parallax image, the judgment method is not limited to this.

FIG. 6 illustrates an example in which it is judged whether recording of the widespread image is necessary or not based on a coincidence (degree of similarity) between the image of the capturing targeted part and the image of the neighboring part. In this example, the coincidence between the image of the capturing targeted part in the widespread image and the image of the neighboring part is obtained by calculation, then when the coincidence is at least a predetermined value, it is judged that recording of the widespread image is necessary to make the capturing targeted part clear because there is a similar area around it, and when coincidence is less than the predetermined value, it is judged that recording of the widespread image is unnecessary.

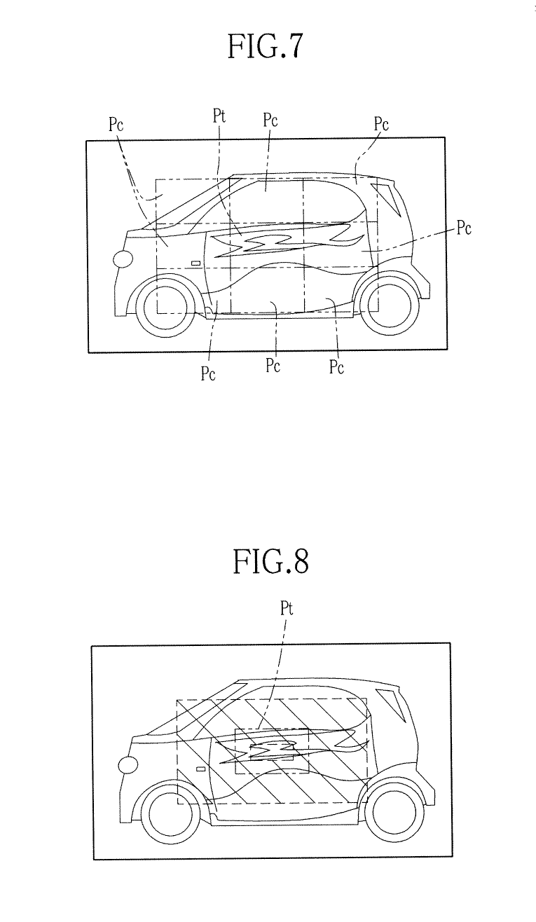

For example as illustrated in FIG. 7, the neighboring part of the image Pt of the capturing targeted part of the parallax image is divided into plural images Pc of the size same as the image Pt, and a histogram of the pixel value of each image Pt, Pc is calculated. Then a difference (absolute value) of the value of the histogram between the same pixel value of the image Pt and the one of images Pc is calculated about each pixel value, and it is determined a reciprocal number of a total value of differences of each pixel value as the coincidence. And then it is judged that recording of the widespread image is necessary when the coincidence of either one of the images Pc is more than the predetermined value.

Note that in the above example, the histogram is used for the judgment of the coincidence, but the method for calculating the coincidence is not limited to this, and for example it may be that the image Pt and each image Pc are divided into plural blocks consisting of suitable number of pixels, that differences between average pixel values of blocks corresponding to the image Pt and each one of the images Pc are calculated, and that a reciprocal number of a total value of the differences is determined as the coincidence. In addition, it may be that the image Pt and each of the images Pc are converted into frequencies and that the coincidence is judged by a comparison between the frequencies.

In addition, the neighboring part is not limited to a surrounding part of the image of the capturing targeted part of the parallax image, and may be an area a part of which overlaps on the capturing targeted part of the parallax image, as illustrated by hatching in FIG. 8. In addition, it may be that when the image of the capturing targeted part and the images Pc being a subject to judgment of the coincidence are sectioned, parts of the areas of the images Pc are mutually overlapped.

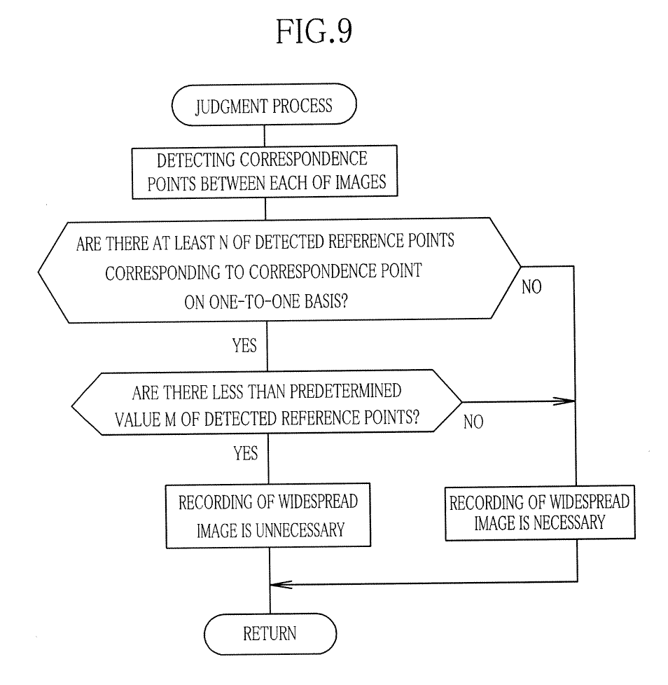

Furthermore, in the judgment process, as an example illustrated in FIG. 9, it may be detected that a correspondence point of each image of the capturing targeted part in the widespread image captured with each camera 11, 12, and it may be judged that whether recording of the widespread image is necessary or not based on the detection result of the correspondence point.

In the example illustrated in FIG. 9, when it is not possible to correctly detect the correspondence point, it is determined that recording of the widespread image is necessary, and when it is possible to correctly perform, the recording is judged to be unnecessary. In this judgment, when the detection number of reference points which correspond to correspondence points one to one is at least a predetermined value N, and the detection number of reference points for which plural correspondence point candidates, which are to be candidates of the correspondence point, are found is at least a predetermined value M, it is judged that the detection of the correspondence point can be performed correctly and recording of the widespread image is unnecessary, and in other cases, it is judged that the detection of the correspondence point cannot be performed correctly and recording of the widespread image is necessary.

According to degree of characteristic of the capturing targeted part when recording of the widespread image is necessary, the number of the pixels of the parallax image and so on, the values N and M to be used for the above judgment may be determined more than 1 appropriately. The value N becomes the standard value to judge a quantity of characteristic parts in the capturing targeted part which are necessary to be distinguished from other parts, and when this value N is the bigger, the widespread image is recorded even in case the capturing targeted part is the more easily distinguished from other parts. On the other hand, the value M becomes the standard value to judge a quantity of parts in capturing targeted part which cannot be distinguished from other parts for example because there are many repetition patterns and are not a pattern and a shade, and when this value M is the bigger, the widespread image is not recorded even in case the capturing targeted part is the more hardly distinguished from other parts.

Note that in this example, although both of the value N and the value M are used for judging whether recording of the widespread image is necessary or not, only the value Nor the value M may be used for judging whether recording of the widespread image is necessary or not. In addition, instead of each image of the capturing targeted part in the widespread image, the parallax image captured in the focal length for measurement may be used.

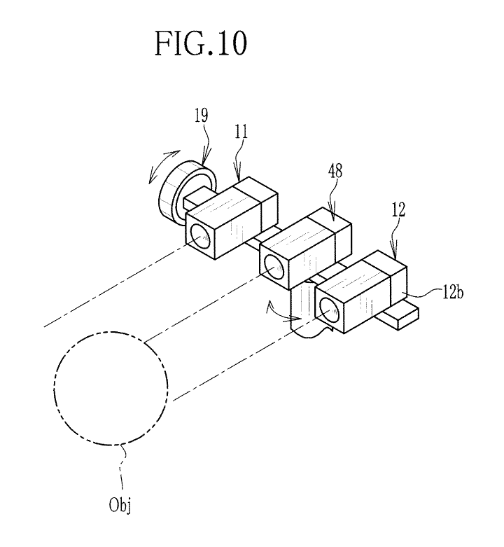

FIG. 10 illustrates a configuration in which a camera for capturing the widespread image is provided in addition to the camera for capturing the parallax image. The first and second cameras 11 and 12 are set in the focal length for measurement to capture the parallax image, and a third camera 48 is set in the focal length for general view. This third camera 48 is fixed to the pan head 19, and its capturing direction is changed with the first and second cameras 11 and 12 so that a center of an image capturing range becomes approximately in agreement with those of the first and second cameras 11 and 12.

Note that it may be that the capturing direction of the third camera 48 is independently changed regardless of the first and second cameras 11 and 12. Also in this case, it may be controlled so that the center of the image capturing range becomes approximately in agreement with those of the first and second cameras 11 and 12. In addition, it may be controlled so that the third camera 48 always captures the whole of the measurement object Obj, without depending on the capturing directions of the first and second cameras 11 and 12.

### Second Embodiment

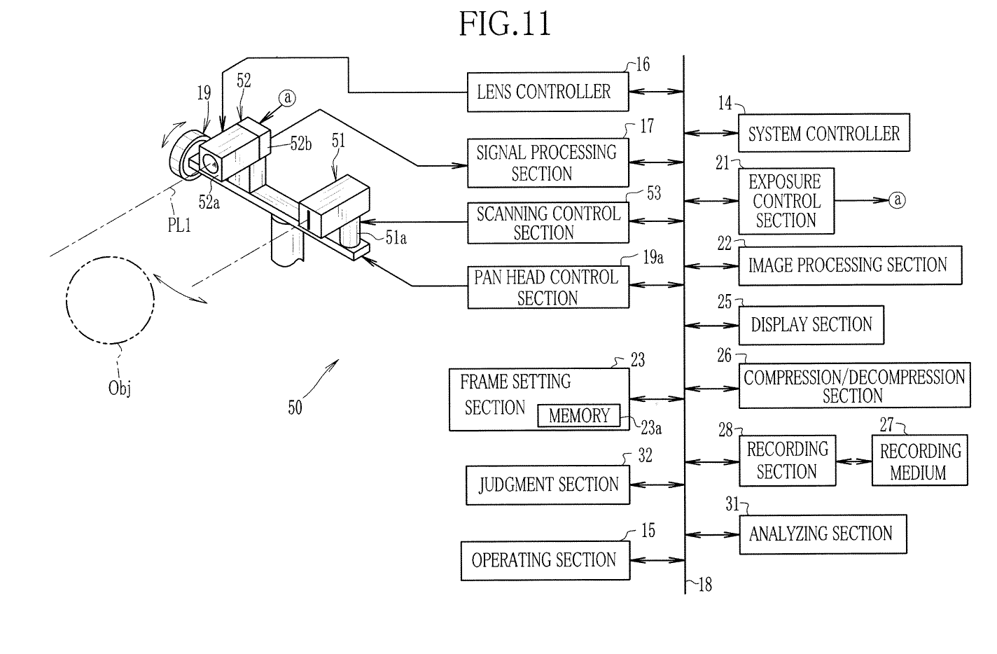

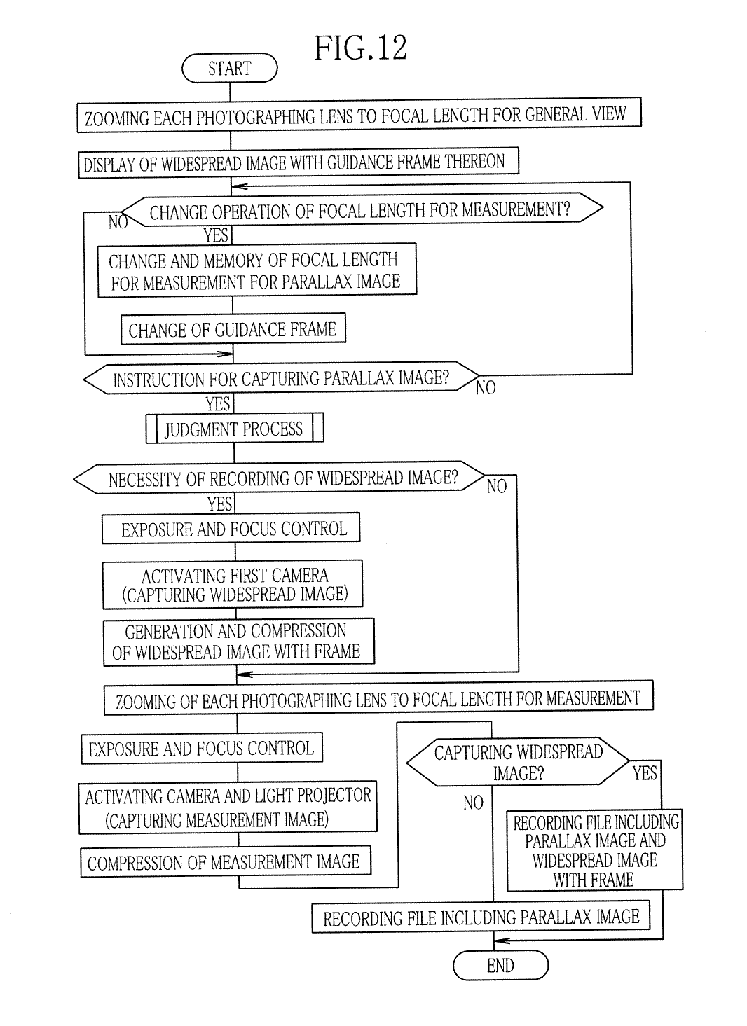

A constitution of a three-dimensional information obtaining device of a second embodiment is illustrated in FIGS. 11 and 12. This three-dimensional information obtaining device 50 measures three-dimensional information of the measurement object by light-section method. Note that the three-dimensional information obtaining device 50 is the same as the first embodiment except that the measurement object is irradiated with slit light and is captured with use of one camera, and same reference numbers are given to the members having substantially same functions, and the explanations of them are omitted.

On the pan head 19, a light projector 51 and a camera 52 are located. The light projector 51 irradiates the measurement object Obj with slit light which has a vertically elongated slip-shape and is output from for example a laser devices, in the measurement capturing mode. This light projector 51 has a scanning mechanism 51a whose operation is controlled by a scanning control section 53, and a movement of the irradiation position of the slit light by this scanner 51a and irradiation of the slit light are repeatedly carried out.

The camera 52 includes a taking lens 52a and an image sensor section 52b. This camera 52 is controlled in the same way as the first camera 11 of the first embodiment, and the widespread image is captured with the focal length for general view in the setting mode and the widespread image capturing mode, and the measurement image is captured with the focal length for measurement in the measurement capturing mode.

In the measurement capturing mode, by performing electric charge accumulation in the image sensor section 52b while an irradiation position of the slit light sequentially travels in the range to be captured as the measurement image, a large number of slit lights of different irradiation positions are captured on one sheet of image for measurement. The analyzing section 31 analyzes the image for measurement captured as above and calculates the three-dimensional information of the measurement range of the measurement object Obj. Note that it may be constituted so that one sheet of measurement image is captured whenever an irradiation position of the slit light moves.

Also in this example, as illustrated in FIG. 12, the necessity or not of recording of the widespread image is judged, and when it is judged that recording of the widespread image is necessary, the widespread image is captured with the camera 52, and then the widespread image with the frame which is made by composing the guidance frame on the widespread image is recorded. Note that in the judgment process, the judging method based on whether the distinctive pattern can be detected or not, and the judging method based on the coincidence (degree of similarity) between the image of the capturing targeted part and the image of the neighboring part, which are described in the first embodiment, can be used.

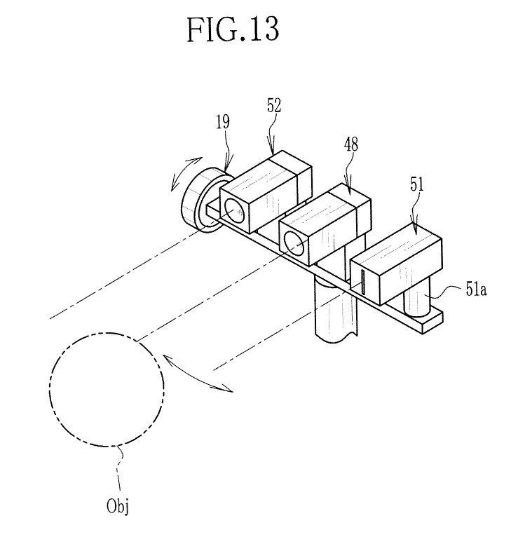

In the second embodiment, although the three-dimensional information obtaining device using light-section method is explained, but this invention is not limited to this, and can be applied to various three-dimensional information obtaining devices which irradiates the measurement object with light from the light projector, and captures the image as the measurement image. For example, this invention can be applied to a device in which a grid pattern is projected to the measurement object from the light projector and a deformation grid image on the work is captured as measurement image with use of a camera, and to a device in which spot light irradiated on the measurement object from the light projector is captured as the measurement image with use of a camera. In addition, like the example illustrated in FIG. 10, as illustrated in FIG. 13, a camera 48 for capturing the widespread image may be provided.

In each of above-described embodiments, although the widespread image is recorded in relation with the measurement image, but may be recorded in relation with the three-dimensional information obtained from the measurement image, instead of the measurement image. In addition, it may be that analysis of the three-dimensional information is performed with use of an external equipment such as a PC and so on.

1. An image capturing apparatus comprising:
an image capturing section which includes a plurality of cameras including a first camera having a taking lens of variable-focus type, wherein each camera captures a measurement part of a measurement object in the same focal length when capturing a parallax image as a measurement image to measure three-dimensional information, and wherein the first camera performs the image capturing with a shorter focal length of the taking lens than the focal length for capturing the parallax image when capturing a widespread image of the measurement object including the measurement part;
a judgment section which judges whether recording of the widespread image is necessary or not based on an image of the measurement part or a neighboring part in the measurement object obtained from the image capturing section; and
a record control section which generates and records an image having a guide which represents a range of the parallax image and is superimposed on the widespread image when the judgment section judges that recording of the widespread image is necessary.

2. The image capturing apparatus claimed in claim 1, wherein the image capturing section performs image capturing in a state that the focal length of the first camera is at the wide-angle end when capturing the widespread image.

3. An image capturing apparatus comprising:
a projector which projects measurement light onto a measurement object;
an image capturing section which includes a camera with a taking lens of variable-focus type, captures a measurement image of a measurement part in a measurement object on which the measurement light is projected when capturing the measurement image to measure three-dimensional information, and performs image capturing with a shorter focal length of the taking lens than the focal length for capturing the measurement image when capturing a widespread image of the measurement object including the measurement part;
a judgment section which judges whether recording of the widespread image is necessary or not based on an image of the measurement part or a neighboring part in the measurement object obtained from the image capturing section; and
a record control section which generates and records an image having a guide which represents a range of the parallax image and is superimposed on the widespread image when the judgment section judges that recording of the widespread image is necessary.

4. The image capturing apparatus claimed in claim 1, wherein the judgment section judges that recording of the wide spread image is necessary when the judgment section cannot detect a distinctive pattern in the measurement image.

5. The image capturing apparatus claimed in claim 1, wherein the judgment section judges that recording of the wide spread image is necessary when a degree of similarity between the measurement image and the image of the neighboring part is higher than a predetermined level.

6. The image capturing apparatus claimed in claim 1, wherein the judgment section detects a correspondence point of the parallax image captured by the plurality of cameras, and judges whether recording of the widespread image is necessary or not based on the detection result of the correspondence point.

7. The image capturing apparatus claimed in claim 6, wherein the judgment section detects a reference point corresponding to the correspondence point on a one-to-one basis, judges that recording of the widespread image is unnecessary when the number of the detected reference point is at least a predetermined value N (N is at least 1), and judges that recording of the widespread image is necessary in other cases.

8. The image capturing apparatus claimed in claim 6, wherein the judgment section detects a reference point where a plurality of correspondence point candidates which are candidates of the correspondence point are found, judges that recording of the widespread image is unnecessary when the number of the detected reference point is less than a predetermined value M (M is at least 1), and judges that recording of the widespread image is necessary in other cases.

9. The image capturing apparatus claimed in claim 6, wherein when the judgment section detects a reference point corresponding to the correspondence point on a one-to-one basis and the number of the detected reference point is at least a predetermined value N (N is at least 1), and detects a reference point where a plurality of correspondence point candidates which are candidates of the correspondence point are found and the number of the detected reference point is less than a predetermined value M (M is at least 1), the judgment section judges that recording of the widespread image is unnecessary, and wherein in other cases, the judgment section judges that recording of the widespread image is necessary.

10. A control method of an image capturing apparatus for capturing a measurement image of a part of a measurement object to measure three-dimensional information comprising the steps of:
judging whether recording of a widespread image being captured with a shorter focal length of a taking lens than a focal length for capturing a measurement image is necessary or not based on an image of a measurement part or a neighboring part in a measurement object; and
generating and recording an image having a guide which represents a range of the measurement image and is superimposed on the widespread image, when recording of the widespread image is judged to be necessary.
